(19) United States
(12) Patent Application Publication
(10) Pub. No.: US 2003/0035900 A1
(43) Pub. Date: Feb. 20, 2003

(54) Rust-protective treating method for iron core of vibrating motor

(75) Inventor: Hong-Shou Hsu, Pa-Te City (TW)

Correspondence Address: DOUGHERTY & TROXELL, SUITE 1404, 5205 LEESBURG PIKE, FALLS CHURCH, VA, 22041, US

(73) Assignee: Geor Chi Electronics Co., Ltd.

(21) Appl. No.: 09/930,301

(22) Filed: Aug. 16, 2001

(51) Int. Cl. B05D 3/02; B05D 1/36; B05D 1/18

(52) U.S. Cl. 427/430.1; 427/402; 427/372.2

(57) ABSTRACT

Rust-protective treating method for magnetic iron core. The magnetic iron core is first ground and then the magnetic iron core is washed by a washing device to remove the impurities attaching to the surface of the magnetic iron core. Then, the magnetic iron core is immersed in zinc phosphate solution which washes the surface of the magnetic iron core. Then, the magnetic iron core goes through rust-protective pretreatment and is several times immersed in rustproof paint as necessary. The surface of the magnetic iron core is coated by a dense layer of rustproof paint with sufficient thickness. Then the magnetic iron core is respectively immersed in acrylic and polyester to form a best rust-protection outside the rustproof paint. In the steps of immersion in rustproof paint, acrylic and polyester, a centrifuge can be used to remove and recover the excessive solution on the surface of the magnetic iron core so as to avoid waste and form a more even layer of rustproof material with suitable thickness.

### BACKGROUND OF THE INVENTION

The present invention is related to a rust-protective treating method for magnetic iron core, and more particularly to a rust-protective treatment for enhancing the anti-rust ability of the iron core without greatly increasing the cost.

Vibrating motors have been more and more widely used in various fields. When applied to a crucial environment such as a strictly cold, hot and corrosive environment, the rust-protective ability of the magnetic iron core of the vibrating motor is critical in function and using life.

FIG. 1 is a flow chart of rust-protective treatment for iron core of a conventional vibrating motor. The treating method includes steps of grinding 31, vibration and screening 32, immersion in rustproof oil 33, preheating 34, spraying 35 and baking 36. In the step of grinding 31, the magnetic iron core of the vibrating motor is first ground to remove the irregular edges of the iron core and plane the surface thereof so as to facilitate attachment of solvents. In the step of vibration and screening 32, the powders, dusts and impurities attaching to the surface of the magnetic iron core are removed. In the step of immersion in rustproof oil 33, a layer of rustproof oil is attached to the surface of the magnetic iron core to achieve a preliminary rust-protective effect. Then, the step of preheating 34 serves as a preceding treatment for the next step of spraying 35, whereby the paint is easy to attach to the surface of the magnetic iron core. In the step of spraying 35, a certain thickness of film of paint is formed on the surface of the magnetic iron core. Finally, in the step of baking 36, the paint is dried and hardened to form a rust-protective layer on the surface of the magnetic iron core.

The steps of spraying 35 and baking 36 can be repeatedly performed as necessary so as to form a sufficient thickness of the paint film on the surface of the magnetic iron core.

Through the above rust-protective treatment, the magnetic iron core will have basic rust-protective ability. However, when spraying the paint onto the magnetic iron core, the paint will scatter and float in the air to pollute the environment and lead to waste of the paint. As a result, the production cost will be increased. Moreover, by way of spraying, it is hard to coat the surface of the magnetic iron core with even thickness of paint layer. In addition, it is hard to make the paint deeply fill into the fine pores of the work piece. Therefore, it is hard to achieve a higher anti-rust ability. Furthermore, the uneven thickness of paint coated on the surface of the magnetic iron core will lead to apparent increment of the volume of the magnetic iron core. As a result, the room for installing the magnetic iron core must be correspondingly enlarged.

### SUMMARY OF THE INVENTION

It is therefore a primary object of the present invention to provide a rust-protective treating method for magnetic iron core. After the steps of grinding, washing and immersion in phosphate solution, the magnetic iron core goes through steps of rust-protective pretreatment and several times of immersion in rustproof paint. Therefore, the surface of the magnetic iron core is coated by a dense layer of rustproof paint with sufficient thickness. The rustproof paint can even fill and coat fine pores. Finally, the magnetic iron core is respectively immersed in acrylic and polyester to form a best rust-protection outside the rustproof paint. Therefore, the rust-protective ability is greatly enhanced.

It is a further object of the present invention to provide the above rust-protective treating method for magnetic iron core in which after the steps of immersion in rustproof paint, acrylic and polyester, a centrifuge is used to throw away and recover the excessive coating on the surface of the magnetic iron core so as to avoid waste of the solution and form a more even layer of rustproof material with suitable thickness. Therefore, the rustproof material can be thinner with the precision of coating and the rust-protective ability enhanced. Accordingly, the volume of the product will not be increased and the application of the product can be more mobile.

It is still a further object of the present invention to provide the above rust-protective treating method for magnetic iron core in which after each of the steps washing and immersion, a step of baking is added to speed the drying so as to promote the production efficiency.

The present invention can be best understood through the following description and accompanying drawings wherein:

### BRIEF DESCRIPTION OF THE DRAWINGS

FIG. 1 is a flow chart of a conventional rust-protective treating method for magnetic iron core;

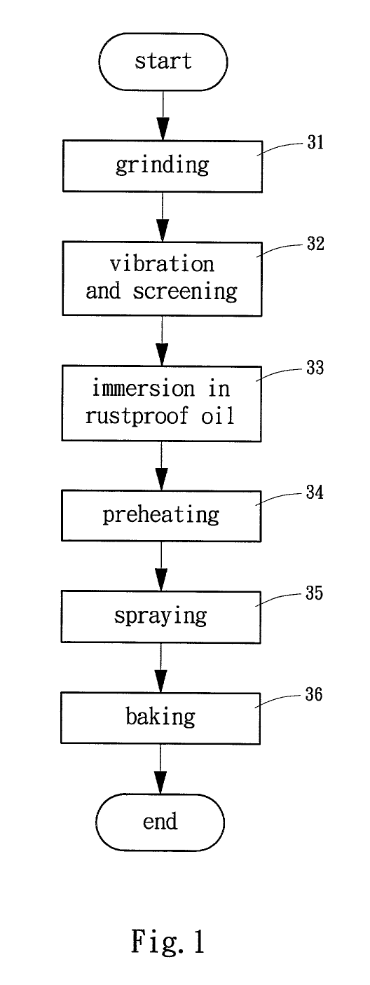

FIG. 2 is a flow chart of the rust-protective treating method for magnetic iron core of the present invention; and

FIG. 3 is a detailed flow chart of the step of immersion of the rust-protective treating method for magnetic iron core.

### DETAILED DESCRIPTION OF THE PREFERRED EMBODIMENTS

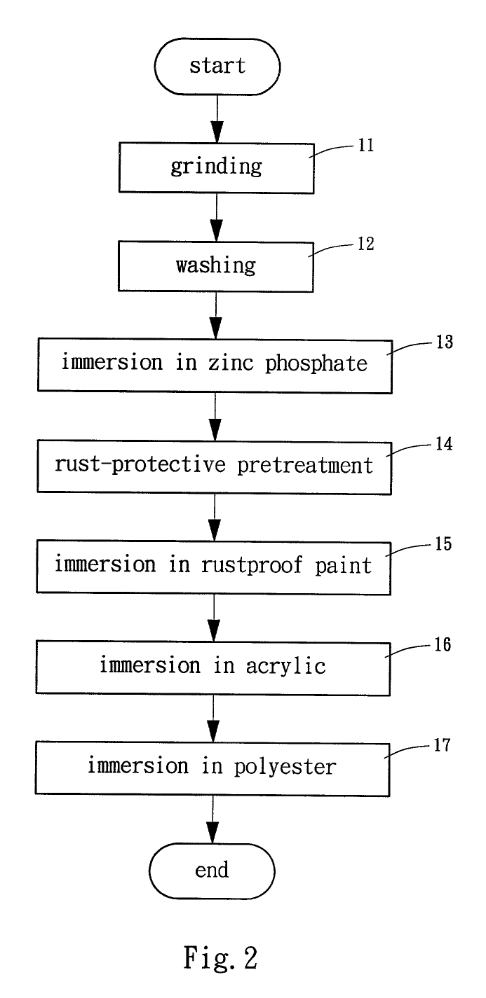

Please refer to FIG. 2 which is a flow chart of the present invention. The rust-protective treating method of the present invention includes steps of grinding 11, washing 12, immersion and corrosion 13, rust-protective pretreatment 14, immersion in rustproof paint 15, immersion in acrylic 16 and immersion in polyester 17. In the step of grinding 11, the iron core is ground to remove the irregular edges and particles produced during molding or hardening. At the same time, the acute (right) angle of the edge of the magnetic iron core is ground into round guiding angle. Then, in the step of washing 12, the magnetic iron core is washed by ultrasonic wave or other washing measures to remove the powders, dusts and small impurities attaching to the surface of the magnetic iron core. After the magnetic iron core is dried, in the step of immersion and corrosion 13, zinc phosphate solution is used to slightly corrode and wash the surface of the magnetic iron core and fill the fine irregular dents of the surface thereof. After dried, in the step of rust-protective pretreatment 14, the magnetic iron core is immersed in a light alkaline liquid to attach a rustproof layer to the surface of the magnetic iron core. Then, the surface is washed and cleaned by pure water. After dried, the step of immersion in rustproof paint 15 is performed at least one time. After dried, the surface of the magnetic iron core is coated by an even layer of rustproof paint with suitable thickness. Then, in step of immersion in acrylic 16, the surface of the magnetic iron core is coated with a rustproof acrylic layer with intermediate protective function. After dried, finally, in the step of immersion in polyester 17, the outer surface of the magnetic iron core is coated with a layer of rustproof polyester with rust-protective function. After dried, an optimal rust-protection is formed on the surface of the magnetic iron core.

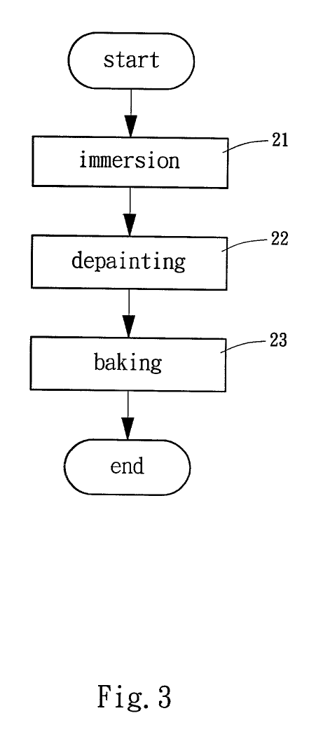

FIG. 3 is a flow chart of the steps of immersion of the present invention. In the steps of immersion in rustproof paint 15, immersion in acrylic 16 and immersion in polyester 17, the immersion procedure includes steps of immersion 21, depainting 22 and baking 23. In the step of immersion 21, the magnetic iron core is directly immersed in the rustproof paint (or liquid acrylic or liquid polyester material), whereby the solution can attach to the surface of the magnetic iron core. When taking out the magnetic iron core, the thickness of the solution attaching to the surface thereof may be too thick and uneven. Therefore, in the step of depainting 22, a centrifugal dehydrator (or other measures such as vibrating and throwing measure) is used to separate and recover the excessive solution on the surface of the magnetic iron core so as to form an even layer of rustproof material with suitable thickness. Therefore, the waste of rustproof solution can be avoided. Finally, the magnetic iron core is baked in step 23 to speed drying.

In order to save the drying time and promote the production efficiency, after the step of rust-protective pretreatment 14, the magnetic iron core can be properly baked to speed drying.

The steps of immersion in rustproof paint 15 can be repeatedly performed as necessary so as to increase the thickness of the rustproof paint attaching to the surface of magnetic iron core and enhance the precision of attachment of the rustproof paint and achieve a best rust-protective ability.

The above embodiments are only used to illustrate the present invention, not intended to limit the scope thereof. Many modifications of the above embodiments can be made without departing from the spirit of the present invention.

What is claimed is:

1. Rust-protective treating method for magnetic iron core, comprising steps of:
a. rust-protective pretreatment in which the magnetic iron core is immersed in a light alkaline liquid to attach a rustproof layer to the surface of the magnetic iron core; and
b. immersion in rustproof paint in which the outer surface and the surface of the pores of the magnetic iron core are all coated with a layer of rustproof paint.

2. Rust-protective treating method for magnetic iron core as claimed in claim 1, after step b further comprising a step c of immersion in acrylic in which the surface of the magnetic iron core is further coated with a rustproof acrylic layer outside the rustproof paint.

3. Rust-protective treating method for magnetic iron core as claimed in claim 2, after step c further comprising a step d of immersion in polyester in which the surface of the magnetic iron core is further coated with a rustproof polyester layer outside the rustproof acrylic layer.

4. Rust-protective treating method for magnetic iron core as claimed in claim 1, wherein each of the steps of immersion comprises steps of:
b1. immersion in which the magnetic iron core is immersed in the rustproof paint or liquid acrylic or liquid polyester material; and
b2. depainting, in which by means of a centrifugal measure, the excessive solution on the surface of the magnetic iron core is separated and recovered.

5. Rust-protective treating method for magnetic iron core as claimed in claim 2, wherein each of the steps of immersion to comprises steps of:
b1. immersion in which the magnetic iron core is immersed in the rustproof paint or liquid acrylic or liquid polyester material; and
b2. depainting, in which by means of a centrifugal measure, the excessive solution on the surface of the magnetic iron core is separated and recovered.

6. Rust-protective treating method for magnetic iron core as claimed in claim 3, wherein each of the steps of immersion comprises steps of:
b1. immersion in which the magnetic iron core is immersed in the rustproof paint or liquid acrylic or liquid polyester material; and
b2. depainting, in which by means of a centrifugal measure, the excessive solution on the surface of the magnetic iron core is thrown away and recovered.

7. Rust-protective treating method for magnetic iron core as claimed in claim 4, wherein the step of depainting is performed by means of a rotary centrifugal measure to throw away the excessive solution on the surface of the magnetic iron core.

8. Rust-protective treating method for magnetic iron core as claimed in claim 5, wherein the step of depainting is performed by means of a rotary centrifugal measure to throw away the excessive solution on the surface of the magnetic iron core.

9. Rust-protective treating method for magnetic iron core as claimed in claim 6, wherein the step of depainting is performed by means of a rotary centrifugal measure to throw away the excessive solution on the surface of the magnetic iron core.

10. Rust-protective treating method for magnetic iron core as claimed in claim 1, wherein the step of immersion is repeatedly performed.

11. Rust-protective treating method for magnetic iron core as claimed in claim 2, wherein the step of immersion is repeatedly performed.

12. Rust-protective treating method for magnetic iron core as claimed in claim 3, wherein the step of immersion its repeatedly performed.

13. Rust-protective treating method for magnetic iron core as claimed in claim 1, wherein after at least one of the steps is performed, a step e of baking is added to speed the drying.

14. Rust-protective treating method for magnetic iron core as claimed in claim 2, wherein after at least one of the steps is performed, a step e of baking is added to speed the drying.

15. Rust-protective treating method for magnetic iron core as claimed in claim 3, wherein after at least one of the steps is performed, a step e of baking is added to speed the drying.

16. Rust-protective treating method for magnetic iron core as claimed in claim 4, wherein after at least one of the steps is performed, a step e of baking is added to speed the drying.

17. Rust-protective treating method for magnetic iron core as claimed in claim 5, wherein after at least one of the steps is performed, a step e of baking is added to speed the drying.

18. Rust-protective treating method for magnetic iron core as claimed in claim 6, wherein after at least one of the steps is performed, a step e of baking is added to speed the drying.

19. Rust-protective treating method for magnetic iron core as claimed in claim 7, wherein after at least one of the steps is performed, a step e of baking is added to speed the drying.

20. Rust-protective treating method for magnetic iron core as claimed in claim 8, wherein after at least one of the steps is performed, a step e of baking is added to speed the drying.

21. Rust-protective treating method for magnetic iron core as claimed in claim 9, wherein after at least one of the steps is performed, a step e of baking is added to speed the drying.

22. Rust-protective treating method for magnetic iron core as claimed in claim 10, wherein after at least one of the steps is performed, a step e of baking is added to speed the drying.

23. Rust-protective treating method for magnetic iron core as claimed in claim 11, wherein after at least one of the steps is performed, a step e of baking is added to speed the drying.

24. Rust-protective treating method for magnetic iron core as claimed in claim 12, wherein after at least one of the steps is performed, a step e of baking is added to speed the drying.

25. Rust-protective treating method for magnetic iron core as claimed in claim 1, before step a further comprising step f of immersion and corrosion in which zinc phosphate solution or other similar solvent is used to slightly corrode and wash the surface of the magnetic iron core.

26. Rust-protective treating method for magnetic iron core as claimed in claim 2, before step a further comprising step f of immersion and corrosion in which zinc phosphate solution or other similar solvent is used to slightly corrode and wash the surface of the magnetic iron core.

27. Rust-protective treating method for magnetic iron core as claimed in claim 3, before step a further comprising step f of immersion and corrosion in which zinc phosphate solution or other similar solvent is used to slightly corrode and wash the surface of the magnetic iron core.

28. Rust-protective treating method for magnetic iron core as claimed in claim 1, before step a further comprising step g of washing in which a washing measure is used to remove the impurities attaching to the surface of the magnetic iron core.

29. Rust-protective treating method for magnetic iron core as claimed in claim 2, before step a further comprising step g of washing in which a washing measure is used to remove the impurities attaching to the surface of the magnetic iron core.

30. Rust-protective treating method for magnetic iron core as claimed in claim 3, before step a further comprising step g of washing in which a washing measure is used to remove the impurities attaching to the surface of the magnetic iron core.

31. Rust-protective treating method for magnetic iron core as claimed in claim 28, wherein the washing measure is an ultrasonic washing device.

32. Rust-protective treating method for magnetic iron core as claimed in claim 29, wherein the washing measure is an ultrasonic washing device.

33. Rust-protective treating method for magnetic iron core as claimed in claim 30, wherein the washing measure is an ultrasonic washing device.

34. Rust-protective treating method for magnetic iron core as claimed in claim 28, before step a further comprising step h of grinding in which the outer surface of the magnetic iron core is ground to remove the irregular edges and particles on the surface and round the edges of the magnetic iron core.

35. Rust-protective treating method for magnetic iron core as claimed in claim 29, before step a further comprising step h of grinding in which the outer surface of the magnetic iron core is ground to remove the irregular edges and particles on the surface and round the edges of the magnetic iron core.

36. Rust-protective treating method for magnetic iron core as claimed in claim 30, before step a further comprising step h of grinding in which the outer surface of the magnetic iron core is ground to remove the irregular edges and particles on the surface and round the edges of the magnetic iron core.

37. Rust-protective treating method for magnetic iron core as claimed in claim 1, before step a further comprising step h of grinding in which the outer surface of the magnetic iron core is ground to remove the irregular edges and particles on the surface and round the edges of the magnetic iron core.

38. Rust-protective treating method for magnetic iron core as claimed in claim 2, before step a further comprising step h of grinding in which the outer surface of the magnetic iron core is ground to remove the irregular edges and particles on the surface and round the edges of the magnetic iron core.

39. Rust-protective treating method for magnetic iron core as claimed in claim 3, before step a further comprising step h of grinding in which the outer surface of the magnetic iron core is ground to remove the irregular edges and particles on the surface and round the edges of the magnetic iron core.
